(19) United States
(12) Patent Application Publication
(10) Pub. No.: US 2020/0204338 A1
(43) Pub. Date: Jun. 25, 2020

(54) SECURING PUBLIC KEY CRYPTOGRAPHIC ALGORITHMS

(71) Applicant: RIPPLE LABS INC., San Francisco, CA (US)

(72) Inventor: Nikolaos Dimitrios Bougalis, Las Vegas, NV (US)

(21) Appl. No.: 16/228,280

(22) Filed: Dec. 20, 2018

(51) Int. Cl. H04L 9/00; H04L 9/08; H04L 9/06; H04L 9/32; H04L 9/30

(52) U.S. Cl. CPC H04L 9/002; H04L 9/0891; H04L 9/0643; H04L 2209/56; H04L 9/30; H04L 2209/38; H04L 9/3247

(57) ABSTRACT

Systems and techniques are provided for securing public key cryptographic systems and algorithms against cryptographic attacks such as attacks implemented on a quantum computer, via public key identifier rotation.

### BACKGROUND

A distributed or decentralized system for electronic transactions involving assets may include a decentralized structure for recording transactions such as a blockchain or ledger and a mechanism for establishing trust in transactions performed by users of the system. The latter is particularly important because a fundamental feature of a decentralized transaction system is the elimination of a centralized trusted entity such as a bank and/or a government to insure trust. For example, cryptocurrency technologies provide for the exchange of coins (currency) using a decentralized infrastructure. Cryptocurrency users may store digital assets or coins in a digital wallet, which records the necessary digital information characterizing a particular user's coin holdings. Users may exchange cryptocurrency using their respective wallets. Among the numerous potential advantages of cryptocurrency are efficiencies in monetary exchange due to the elimination of a centralized banking entity.

Typically, cryptocurrency systems such as bitcoin, which utilize a decentralized ledger, expose a public key (based upon a public key cryptographic algorithm) in the ledger, for example, the public key of an agent performing a transaction. The public key is associated with a private key, which is related to the public key via a cryptographic algorithm typically relies upon one of three hard mathematical problems: the integer factorization problem, the discrete logarithm problem or the elliptic-curve discrete logarithm problem to ensure deriving the private key from the public key. However, all of these problems can be easily solved on a sufficiently powerful quantum computer running Shor's algorithm. Although current quantum computers lack the processing power to break known cryptographic algorithms, new algorithms are being developed to prepare for future implementation of quantum computers that may possess the requisite computational power to pose a security threat.

Post-quantum cryptography (sometimes referred to as quantum-proof, quantum-safe or quantum-resistant) refers to cryptographic algorithms (usually public-key algorithms) that are thought to be secure against an attack by a quantum computer. Currently, this is not true for the most popular public-key algorithms, which can be efficiently broken by a sufficiently strong hypothetical quantum computer. In contrast to the threat quantum computing poses to current public-key algorithms, most current symmetric cryptographic algorithms and hash functions are considered to be relatively secure against attacks by quantum computers.

Because the public key associated with an entity in a decentralized transaction system is typically exposed in a ledger or blockchain, malicious actors can glean the public key and using a quantum algorithm may then recover the private key, thereby breaching security with respect to the entity. Thus, techniques are necessary to provide security for public key cryptographic algorithms especially those algorithms that may be implemented on a quantum computer.

### BRIEF DESCRIPTION OF THE DRAWINGS

FIG. 1a depicts a process for automatically securing transactions in a decentralized transaction process from attacks on a public key exposes in the ledger according to one embodiment of the present disclosure.

FIG. 2a is a flowchart of a process for automatically securing transactions in a decentralized transaction process from attacks on a public key exposed in the ledger according to one embodiment of the present disclosure.

FIG. 2a1 is a process that may be performed by a decentralized transaction system to carry out an atomic transaction for an operation to be performed with respect to an entity in a decentralized ledger and a public key rotation according to one embodiment of the present disclosure.

FIG. 2b is a flowchart depicting a process for the generation of an address from a random seed according to an embodiment of the present disclosure.

FIG. 2c is a flowchart for performing an authentication of a transaction according to an embodiment of the present disclosure.

FIG. 3a depicts a process for the generation of an address from a random seed according to an embodiment of the present disclosure.

FIG. 3b depicts a process for the generation of a transaction triple according to an embodiment of the present disclosure.

FIGS. 3c-3d depicts a process for performing an authentication of a transaction according to an embodiment of the present disclosure.

FIG. 4a is a high level block diagram of a decentralized transaction system according to an embodiment of the present disclosure.

FIG. 4b is a block diagram of a decentralized transaction system according to an embodiment of the present disclosure.

FIG. 4c depicts an example of a ledger in graphical form according to an embodiment of the present disclosure.

FIG. 5a is a high level flowchart of a consensus algorithm according to an embodiment of the present disclosure.

FIG. 5b is a flowchart depicting an operation of a transaction thread according to an embodiment of the present disclosure.

FIG. 5c is a flowchart depicting an operation of a proposal thread according to an embodiment of the present disclosure.

FIG. 5d is a flowchart depicting an operation of a voting thread according to an embodiment of the present disclosure.

FIG. 5e is a flowchart depicting an operation of a proposal generation/validation thread according to an embodiment of the present disclosure.

FIG. 6 is a block diagram of a consensus system according to an embodiment of the present disclosure.

### DETAILED DESCRIPTION

Distributed ledgers are gaining interest for use in a wide variety of transactional systems. For example, many cryptocurrency-based systems use a form of a distributed ledger or similar transaction system to record transactions between holders of cryptocurrencies or similar transactions. As a specific example, a shared distributed ledger may be implemented on a blockchain that records every transaction that occurs in a cryptocurrency system.

Decentralized transaction systems typically employ a public key cryptographic process determine authentication of transactions performed by agents (people or entities using the decentralized transaction system). The public key cryptographic process relies upon a public key and associated private key that are generated from a random seed or secret. The private key and secret are held privately by an agent, while the public key is typically publicly disclosed. Only transactions that are cryptographically signed by the private key as determined by applying the public key are authenticated. The private key is related to the public key with respect to the solution of a hard problem such as the integer factorization problem, the discrete logarithm problem or the elliptic-curve discrete logarithm problem. These hard algorithms protect against malicious agents deriving the private key from the public key using classical computation processes.

However, all of these hard problems can easily be solved on a sufficiently powerful quantum computer running Shor's algorithm. When agents interact with a decentralized ledger, upon performing transactions with respect to an entity a public key associated with the entity or agent is typically published in the ledger and may be retrieved by potential malicious actors (e.g., hackers). In particular, were a malicious actor to be equipped with a quantum computer the agent could crack (derive) the private key associated with a public key gleaned from the decentralized ledger thereby creating a significant security vulnerability.

Embodiments disclosed herein provide solutions to this and other aspects of conventional asset transfer systems. In particular, according to embodiments, the attack time for a malicious actor to glean a public key reflected in a decentralized ledger (or other public record) is significantly reduced. This may be accomplished by for each transaction submitted to a decentralized transaction system, automatically performing an associated public key identifier rotation process. As previously mentioned, the public key identifier may assume the form of an address that is generated from the actual public key by applying a hash function followed by an encoding function. According to one embodiment of the present disclosure, the submitted transaction and the public key identifier rotation collectively are treated as an atomic transaction with respect to the decentralized ledger. Because the decentralized ledger reflects the prior public key and not the new public key (rotated key), were a malicious actor to extract the public key from the decentralized ledger, that actor would not be able to derive the current and thereby valid private key as the current private key is associated with the rotated public key, which is not openly reflected in the decentralized ledger.

According to one embodiment of the present disclosure, the public key identifier rotation may be achieved by for each submitted transaction performing a process to generate a new public key identifier and upon submitting the transaction to the decentralized transaction system, providing the new public key identifier as a parameter with the submitted transaction. The decentralized transaction system may be accordingly adapted to retrieve the submitted parameter (new public key identifier) from the submitted transaction and rotate the old public key identifier to the new public key identifier. Although the old public key is reflected for the transaction in the decentralized ledger, because the public key identifier has been rotated, it is not useful to malicious users as only the new public key identifier can be used to perform transaction with respect to the entity.

Using these techniques for securing for securing the public key cryptographic process utilized by a decentralized transaction system, agents may freely perform transactions with respect to entity with significantly reduced risk that an attacker could derive the private key associated with a public key and thereby breach the integrity of the system. In particular, as will be defined in detail below, each agent may be associated with one or more information elements in the ledger (which may be a decentralized ledger), herein referred to as an entity (defined in detail below), that is addressable within the ledger by virtue of being associated with a unique address (described below)). As will become evident herein, an entity operates as an object for storage of assets and may be associated or owned by an agent by virtue of the agent holding a secret key from which the entity's address is uniquely generated.

According to an embodiment of the present disclosure, the assets associated with an entity may be represented by an account line also referred to as a trust line that represents the indebtedness of a first entity to a second entity with respect to one or more assets. By virtue of the respective association of each entity with an agent, this informational structure facilitates the creation of accounts in the decentralized ledger. The association of an agent with an entity effectively establishes the agent's ownership of assets associated with the entity itself

In an embodiment, any changes to the state of entities and accounts such as the creation of entities, assignment of an address to an entity, creation of accounts between a first entity and a second entity may require the successful creation, submission, authentication and verification of one or more associated transactions in a decentralized transaction system. According to an embodiment of the present disclosure, transactions submitted to the decentralized transaction system are reflected in a decentralized ledger only if such transactions are authenticated and verified using a decentralized consensus process and system. The decentralized ledger reflects the “ground truth” of trusted transactions in the decentralized transaction system and the operation of consensus operates to establish trust for participants (agents) utilizing the decentralized transaction system.

According to an embodiment of the present disclosure, each entity in the ledger is associated with the respective address, which may be generated from a random seed or secret key. The address serves as an absolute identifier for an entity. In particular, according to one embodiment of the present disclosure, the address is generated from a master public key using techniques described herein. The master public key may subsequently be permanently disabled upon agent command whereby a rotatable regular key is then associated with an entity facilitating the security techniques described herein. Nonetheless, the address derived from the master public key remains the permanent and persistent identifier for the entity.

Definitions

Decentralized Transaction System

In addition to its common usage, for purposes of the present disclosure, the term “decentralized transaction system” refers to one or more computing devices that operate collectively to perform transactions between one or more agents (described in detail below). The computing devices may be arranged in a peer-to-peer or similar configuration. As will be described in more detail below, according to an embodiment of the present disclosure, a decentralized transaction system may further include a peer to peer layer, a decentralized consensus layer and a decentralized ledger layer. As will become evident herein, a plurality of servers may operate to independently perform a consensus process wherein such servers interoperate via communication over the peer-to-peer layer for the exchange of information. Further, each server may accept transactions from clients operated by agents, wherein each received transaction effectively represents a candidate change to the decentralized ledger.

Agent

In addition to its common usage, for purposes of the present disclosure, the term “agent” refers to a person, business or other participant in the world utilizing in a decentralized transaction system for the exchange of assets. As will become evident herein, each agent may participate in the decentralized transaction system by using a computing device running a client and associated API, which allows the agent to generate transactions, which may be submitted to the decentralized transactions system for possible inclusion in the decentralized ledger if such transactions are authenticated and validated. Each agent may be associated with one or more entities as described in detail below.

Entity

In addition to its common usage, for purposes of the present disclosure, the term “entity” refers to an object reflected in a virtual double-entry bookkeeping system, for example by utilizing a decentralized ledger, which functions to represent the storage of assets by virtue of accounts established with other entities. As will become evident herein, an entity may operate to reflect one or more accounts through the association of the entity with one or more other entities in a decentralized ledger. Each such association of the entity with another entity may establish a reflected indebtedness, thereby establishing an account. Each entity may be associated with an owner, comprising an agent (defined above). According to an embodiment of the present disclosure, an entity may be associated with a unique address that may be generated from a random seed also referred to a secret key. In particular, as described herein, the address associated with an entity serves as a persistent and permanent universal identifier for the entity and may be generated from a master public key. Upon agent command, the master public key may be disabled permanently in which case, a public key identifier (derived from the regular key) may be associated with a respective identity in addition to the identifier. In particular, the public key identifier may be generated from a secret key. The holding of the secret key from which the public key identifier is generated by an agent establishes the ownership of the entity by the agent as it enables the agent to perform transactions with respect to the entity. According to some embodiments, the public key identifier of an entity may be rotated or changed to a new public by performing an associated public key identifier rotation process using the decentralized transaction system.

Address

In addition to its common usage, for purposes of the present disclosure, the term address refers to a cryptographically generated code or string for uniquely, permanently and persistently identifying an entity in a decentralized transaction system. According to one embodiment of the present disclosure, an address remains fixed for the lifetime of an entity reflected in a decentralized ledger and may be generated by applying an encoding function to a binary hash of a master public key. However, other methods are compatible with techniques described in this disclosure.

Public Key Identifier

In addition to its common usage, for purposes of the present disclosure, the term public key identifier refers to a cryptographically generated code or string associated with an active public key herein referred to as a regular key associated with an entity. The regular key, is a public key that is currently valid for performing transactions with respect to the entity. As will become apparent, according to embodiments, the regular key may be rotated or changed periodically either by agent invocation or automatically by initiating a public key identifier rotation process. Once a public key rotation process is performed, a new regular key becomes the active key for an entity and the old regular key is invalid for performing transactions with respect to the entity. According to one embodiment of the present disclosure, a public key identifier has the same format as an address as described above and may be generated by applying an encoding function to a binary hash of the regular key. However, other methods are compatible with techniques described in this disclosure.

Account

In addition to its common usage, for purposes of the present disclosure, the term “account” refers to a relationship between two entities indicating that one entity owes the other entity a set amount of assets. In the context of an entity (a double-entry accounting system), an account is associated with a balance that can either be viewed as an asset or a liability depending upon whether it is viewed from the perspective of the entity owing the assets or the entity owed the assets.

Offer

In addition to its common usage, for purposes of the present disclosure, the term “offer” refers to the proposition of trading one asset for another at a given price.

Journal

In addition to its common usage, for purposes of the present disclosure, the term “journal” refers to a chronological (temporal) record of transactions between any number of entities. As will be described in more detail below, according to an embodiment of the present disclosure, a journal may be utilized in a decentralized fashion, whereby multiple peer transaction nodes maintain a respective journal.

Ledger

In addition to its common usage, for purposes of the present disclosure, the term “ledger” refers to a record of the state of all transactions at particular moments in time by account. A ledger records the amount of currency in each agent's account and represents the “ground truth” of a decentralized asset transaction system. As will be described in more detail below, according to an embodiment of the present disclosure, a ledger may be utilized in a decentralized fashion, whereby the ledger is effectively a distributed or decentralized database shared with a plurality of nodes. According to this embodiment, multiple peer-to-peer transaction nodes or servers maintain a list of candidate transactions (described below) in an attempt to reach consensus.

According to an embodiment of the present disclosure, a ledger may be updated on some cadence (e.g., every few seconds using a consensus protocol described in more detail below). The last updated ledger for which consensus has been reached is referred to as the last closed ledger (“LCL”).

Transaction

In addition to its common usage, for purposes of the present disclosure, the term “transaction” refers to any proposed change to the ledger. As will be described in more detail below, in a decentralized transaction network, which may further include a plurality of servers arranged in a peer-to-peer network, any server can introduce a transaction to the network provided by a client. That is, an agent utilizing an associated client and API (for example, wherein such client and API execute on a computing device) may submit a transaction to a decentralized transaction system by submitting the transaction to a server. The submitted transaction then assumes a state as a proposed change/modification to the ledger, which may ultimately be reflected in an updated ledger if such transaction is authenticated and verified.

Consensus

In addition to its common usage, for purposes of the present disclosure, the term “consensus” refers to a process that may be executed in a distributed fashion for achieving agreement with some mathematical certainty about one or more transactions to be applied to the ledger with respect to authentication and verification. Consensus functions to establish trust in a decentralized transaction system that would otherwise be established by virtue of a centralized authority such as a bank, which may be backed by a governmental entity. In particular, a consensus process, which may operate in a decentralized fashion, seeks to authenticate each transaction (ensure such transaction was generated by an agent authorized to perform such transaction) as well as verify each transaction (ensure such transaction is valid). An example of an invalid transaction, for example, would be an attempt by an agent to perform double spending, i.e., perform two transactions with respect to an account that in aggregate exceeded the asset limit in the account.

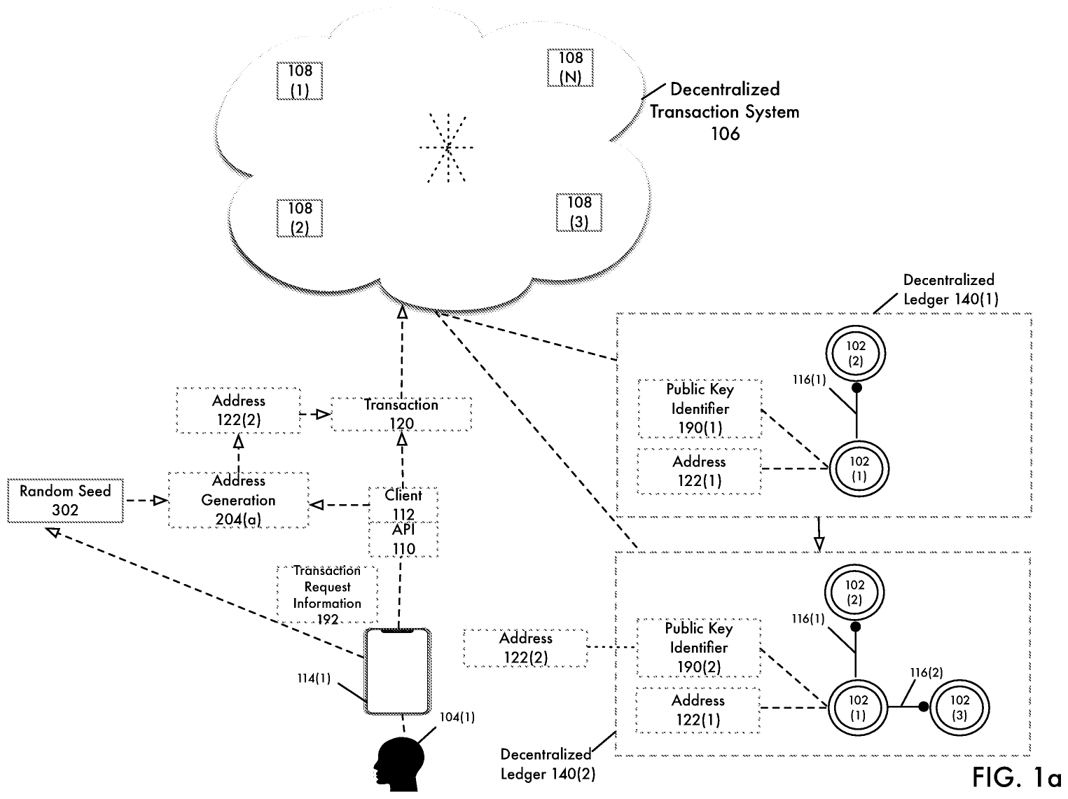

FIG. 1a depicts a process for automatically securing transactions in a decentralized transaction process from attacks on a public key exposes in the ledger according to one embodiment of the present disclosure. In particular, FIG. 1a illustrates a process to protect against the application of quantum algorithms to attempt to deduce the private key associated with a public key by dramatically reducing the attack time window.

In particular, FIG. 1a depicts a process performed by a client to automatically generate a new public key identifier/address 122(2) and its submission as part of transaction 120 with by a client 112 to decentralized transaction system 106. In particular, at high level, FIG. 1a illustrates the evolution of decentralized ledger between states 140(1) and 140(2) respectively corresponding to the state of the decentralized ledger just prior to submission of transaction 120 and just after the submission and successful completion of a consensus process (described in detail below) with respect to transaction 120.

Referring now to FIG. 1a, agent 104(1) utilizes computing device 114(1) to interact with client 112 via API (“Application Programming Interface”) 110 to generate transaction request information 192 that will ultimately be incorporated into transaction 120 to be submitted to decentralized transaction system 106. Transaction request information 192 may comprise any operation with respect to entity 102(1) that is owned by agent 104(1). For example, transaction request information 192 may be a transfer of assets from entity 102(1) to another entity 102(3) thereby establishing an account 116(2) between entity 102(1) and 102(3), etc. Thus, as shown in FIG. 1a and for purposes of illustration only, prior to processing of transaction 120, it is presupposed that account 116(1) has already been established for entity 102(1) respectively with entity 102(2). The arrangement of entity 102(1) with respect to account 116(1) having already established is purely an example for illustration and any other state of affairs is possible. Although the embodiment described with respect to FIG. 1a pertain to operations on a decentralized ledger 140, it will be understood that according to alternative embodiments, transactions may be performed with respect to a centralized ledger or some other bookkeeping entity or system. Further, as will be described below, for purpose of this discussion the terms “decentralized ledger” 140 and “decentralized ledger layer” are used interchangeably as contextually appropriate.

An example structure of transaction 120 will be described in due course. For purposes of the present discussion, it is sufficient to recognize that transaction 120 may be initiated by an agent reflecting a proposed change to decentralized ledger 140 or some other bookkeeping system for representing account information with respect to a plurality of agents 104.

Decentralized transaction system 106 may include an arbitrary number of servers 108(1)-108(N), which may operate in a peer-to-peer network. The operation and structure of a peer-to-peer network will be understood. However, for purposes of the present discussion, it is sufficient to recognize that a peer-to-peer network may include any collection of resources that may communicate without the need for any centralized coordination such as via a central server, for example. Servers 108(1)-108(N) may operate to collectively perform consensus operations with respect to transactions initiated on decentralized transaction system 106 and relatedly maintain and update decentralized ledger 140. For example, each server 108(1)-108(N) may maintain a respective journal of transactions initiated by clients 112 running on respective computing devices (e.g. 114(1)).

Computing device 114(1) may be any device associated with a central processing unit such as a desktop computer, a mobile device, a tablet device, electronic watch, etc. Agent 104 may interact with computing device 114 using any method such as a keyboard and mouse, voice, etc. Client 112 may include any process, framework or other software based structure executing on client 114(1) that allows agent 104(1) to interact with decentralized transaction system 106. According to an embodiment of the present disclosure, client 112 operates as a digital wallet for performing transactions using decentralized transaction system 106 with respect to one or more entities 102 associated with an agent 104. Agent 104 may utilize client 112 to initiate transactions in decentralized transaction system 106 by interacting with one of the servers 108(1)-108(N). That is, agent 104 may desire to perform a particular transaction 120 with respect to decentralized transaction system 106.

Client 112 may provide an interface (graphical or otherwise) by which agent can select various functions accessible via API 110 for initiating a transaction with respect to decentralized transaction system 106. Client 112 may then perform a processes to generate an appropriate transaction in an appropriate data format for submission to decentralized transaction system 106, which will then become a candidate transaction for possible inclusion in a ledger, for example, if consensus is reached with respect the transaction. As previously noted, example data structures and processes for generating a suitable data entity for representation of a transaction for submission to decentralized transaction system 106 will be discussed in due course.

As shown in the embodiment depicted in FIG. 1a, API 110 and client 112 are executed on computing device 114(1) and operate as a digital wallet enabling agent 104(1) to perform asset transactions via interactions with decentralized transaction system 106, which are recorded in decentralized ledger 140. As will be appreciated, API 110 provides an interface for calling various methods on client 112. For example, according to an embodiment of the present disclosure, API 110 may provide methods to create an entity 102 in decentralized ledger 140, create a transaction between a first entity 102 and a second entity 102, establish an offer, etc.

API 110 may include any interface for interacting with client 112. According to the embodiment depicted in FIGS. 1a-1d, API 110 and client 112 may execute on computing device 114(1). According to some embodiments, API 110 and client 112 may execute on a remote server in which case, API 110 may include, for example, a RESTful (“Representation State Transfer”) interface, an RPC (“Remote Procedure Call”) interface or any other interface. API 110 may be associated with a set of methods, which are functions or API calls that may be performed with respect to decentralized transaction system 106.

According to an embodiment of the present disclosure and as discussed in more detail below, each API method may receive a transaction field, a transaction signature field and a public key field. The transaction field may include an identifier in either ASCII or binary format specifying the desired transaction. The transaction signature file may include a binary string that is generated by performing a signature operation on the transaction identifier using a public key that was generated from an address 122. The public key field may include a public key that was generated from the random seed 302.

Referring again to FIG. 1a, prior to agent 104(1) initiating transaction 120, the initial state of ledger is depicted in 140(1). Entity 102(1) is associated with address 122(1). Techniques for generating address 122(1) are described below in detail. In particular, according to one embodiment, address 122(1) is generated from a master public key that itself is generated from a random seed. Address 122(1) serves as a permanent and persistent universal identifier for entity 102(1). As previously noted, agent 104(1) may disable the master public key in favor of a regular public key the latter of which may be rotated or changed upon agent command. According to one embodiment, once the master public key is disabled, it is permanently disabled. Thus, this is the arrangement depicted in FIG. 1a. In particular, aside from being associated with address 122(1), entity is also associated with public key identifier 190(1). According to one embodiment of the present disclosure, public key identifier 190(1) utilizes the same format as address 122(1) and in fact is generated in an identical fashion. However, public key identifier 190(1) is generated from a current regular public key and may be changed whereas address 122(1) is generated from the master public key and cannot be changed as it serves as a permanent and persistent universal identifier for entity 102(1).

Furthermore, as shown in FIG. 1a, prior to submission of transaction 120, entity 102(1) has one established account 116(1) with entity 102(2). Note that the state of decentralized ledger prior to submission of transaction 120 as represented in 140(1) is merely one example. According to alternative examples, entity 102(1) may have 0 or more accounts associated with it. Furthermore, public key identifier 190(1) may have been changed any arbitrary number of times.

Against the backdrop of the state of the ledger 140(1) shown in FIG. 1a, agent 104(1) uses computing device 114(1) to interact with API 110 to invoke method calls on client 112 to generate transaction request information 192. Transaction request information 192 may comprise information from which transaction 120 will ultimately be generated, namely an operation that agent 104(1) wishes to perform with respect to entity 102(1). As previously noted, transaction 120 may comprise any operation with respect to entity 102(2) such as transfer of assets to another entity, establishing an account, etc. According to one embodiment of the present disclosure, upon receiving transaction request information 192, client 112 automatically invokes address generation process 204(a), which produces address 122(2). After transaction 120 is submitted to decentralized transaction system 106 and consensus has been achieved, address 122(2) will ultimately serve as a new public key identifier 190(2), replacing the current public key identifier 190(1) in ledger 140(1).

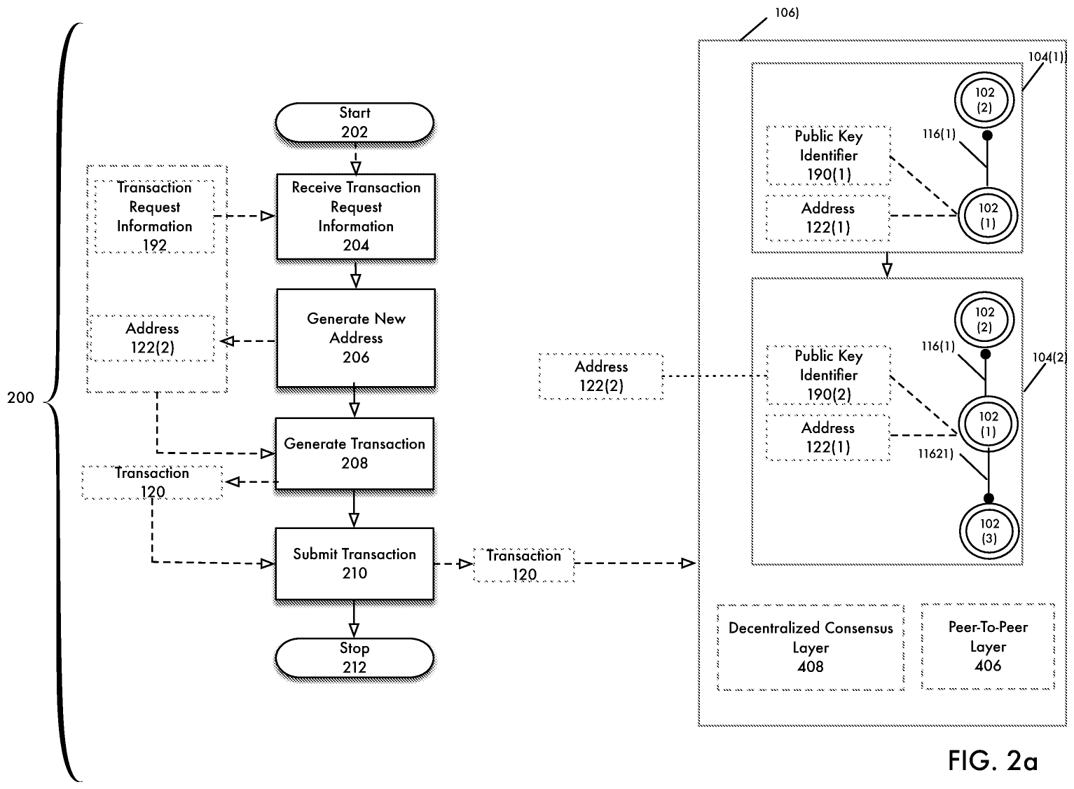

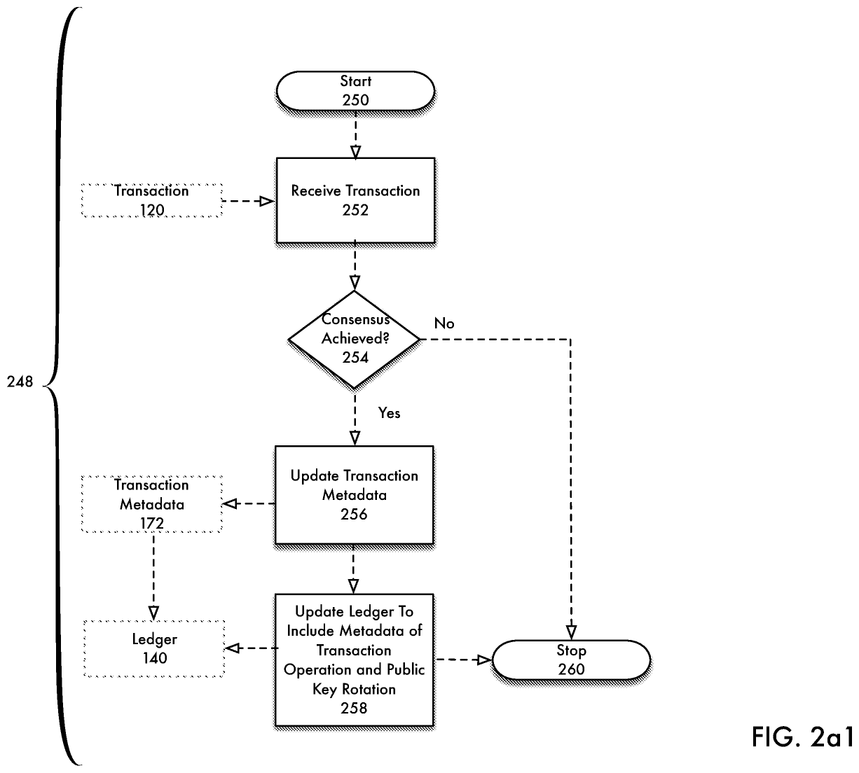

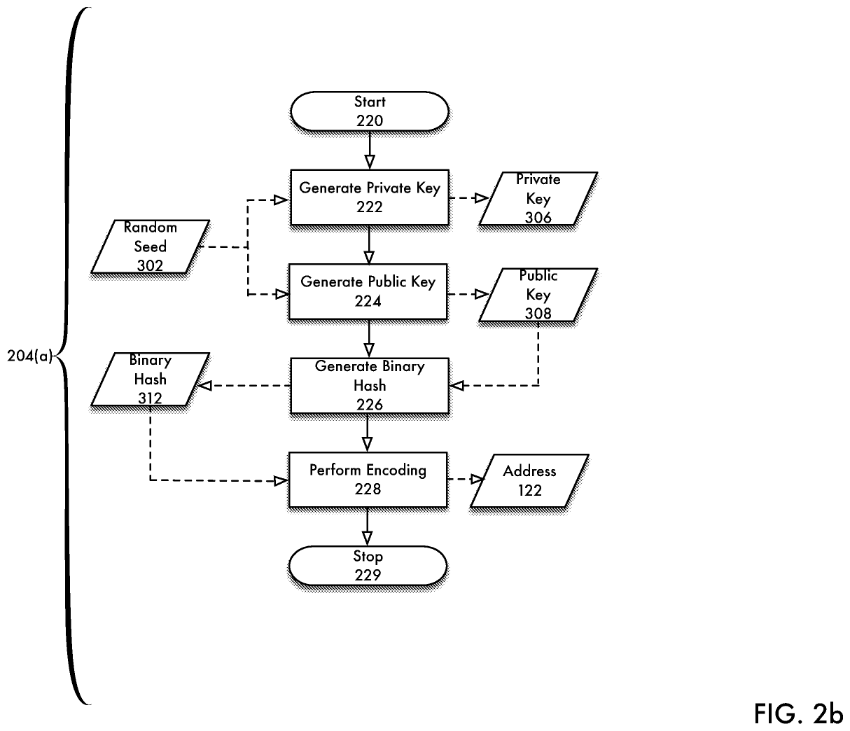

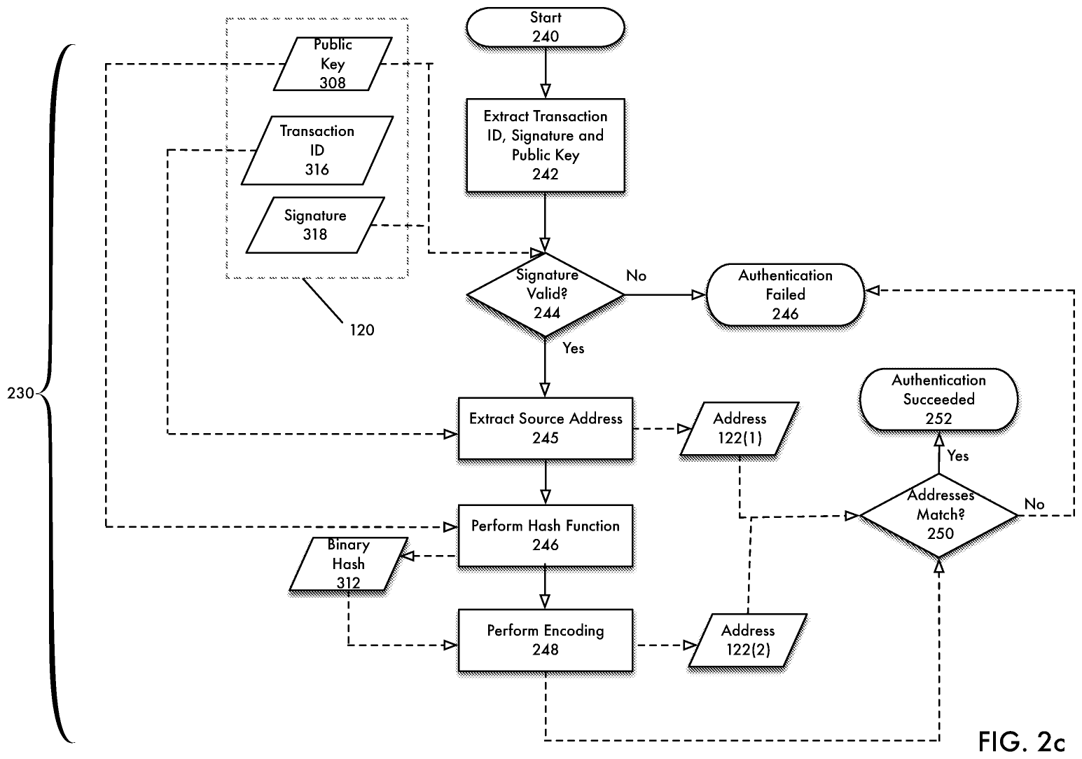

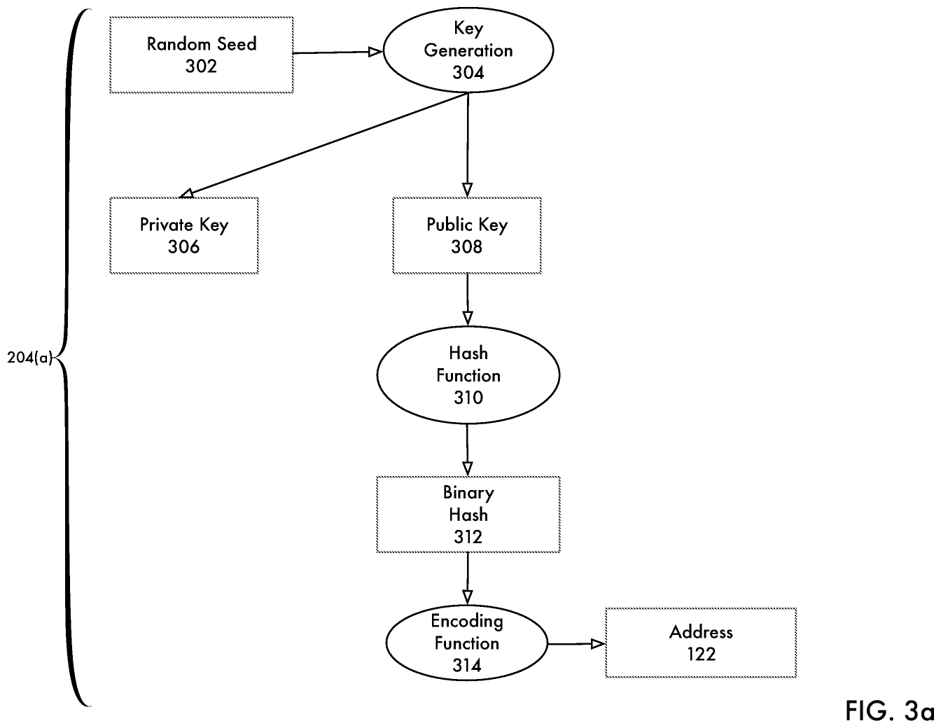

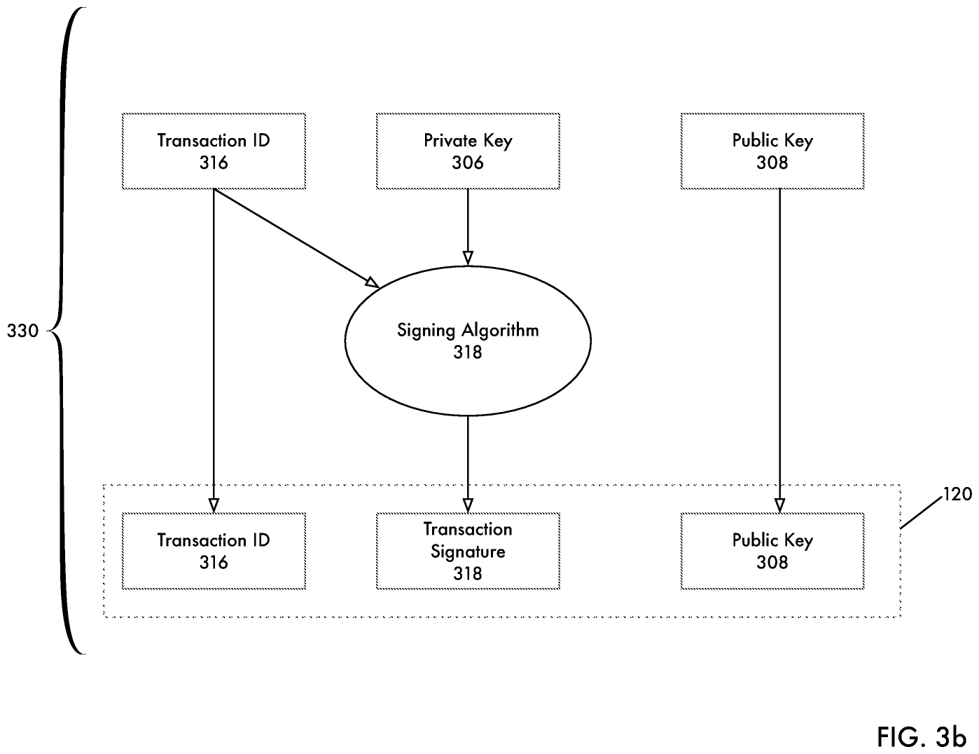

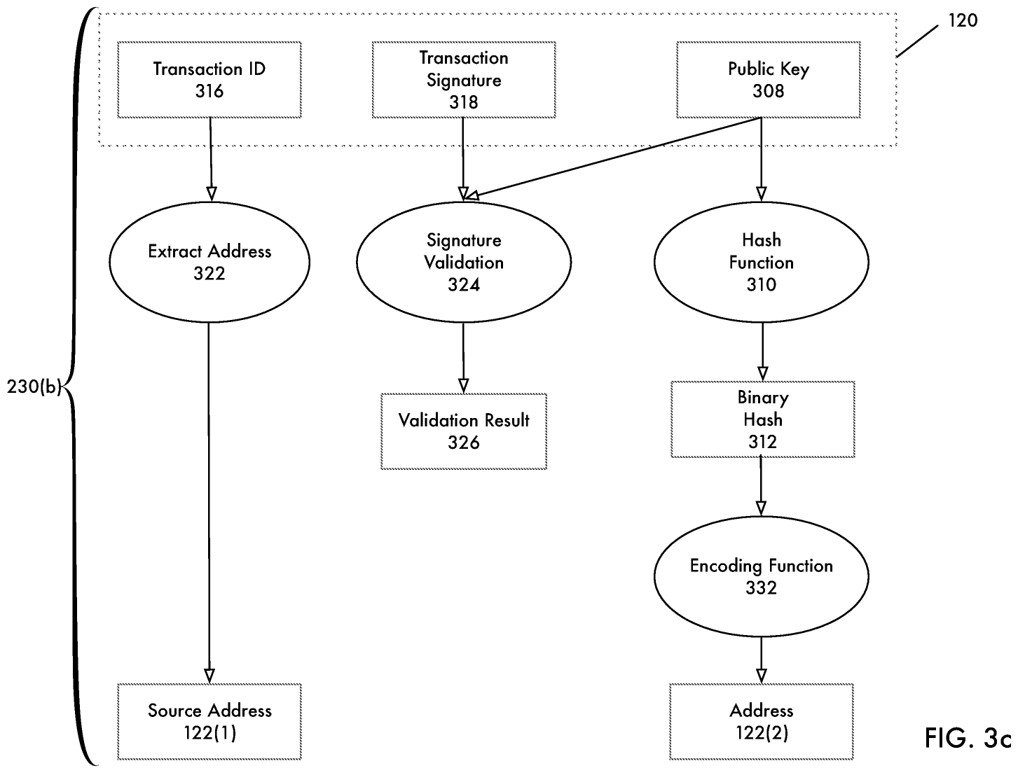

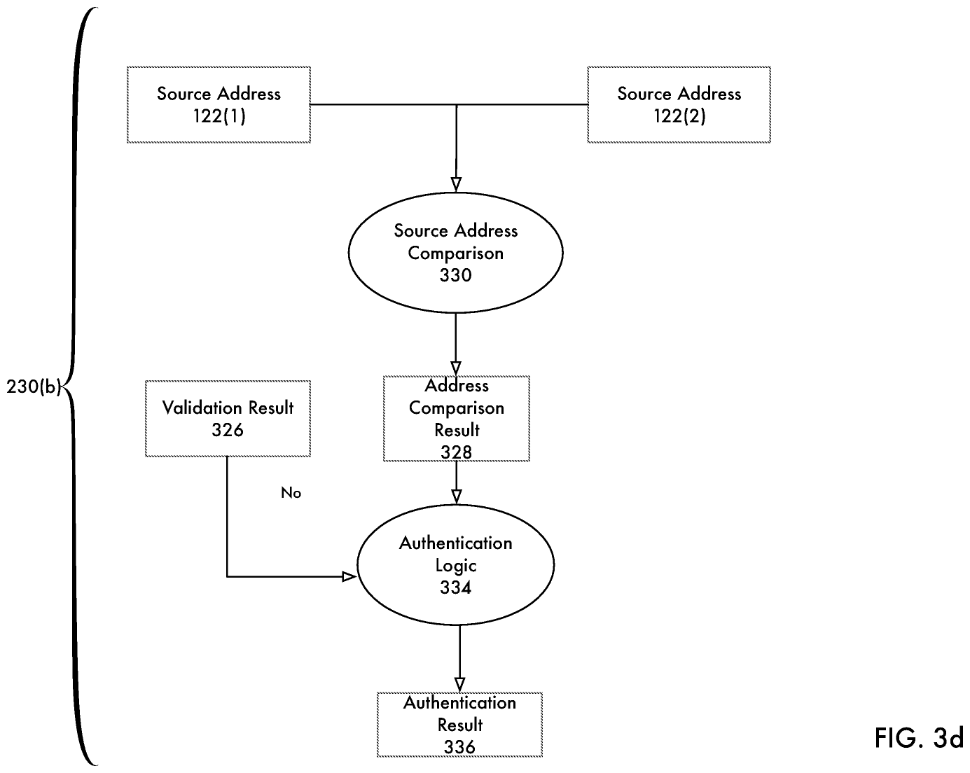

A detailed description of address generation process 204(a) is described below with respect to FIGS. 2b and 3a. For purposes of the present discussion, however, it is sufficient to recognize that agent 104(1) may select a secret key also referred to herein interchangeably as a random seed 302(1) from which address 122(2) is generated. The random seed/secret key 302 is privately held by agent 104(1) such that only agent 104(1) can generate associated address 122(2) due to the fact that the address generation process 204(a) utilizes a one-way function. That is, according to an embodiment of the present disclosure and as described in more detail below, the address generation process 204(a) provides a bijective mapping between the random seed 302(1) and address 122(2).

Upon receiving transaction request information 192, agent 112 appends address 122(2) to transaction request information to generate transaction 120. Transaction 120 may also include the public key associated with the current public key identifier 190(1). According to one embodiment of the present disclosure, address 122(2) may comprise a parameter in transaction 120. Transaction 120 including address 122(2) is then submitted by client 112 to decentralized transaction system 106 whereupon a consensus operation is performed to authenticate and validate transaction 120.

140(2) shows the state of a decentralized ledger upon a successful consensus operation is performed upon transaction 120. In particular, decentralized ledger 140(2) has been updated in two respects from decentralized ledger 140(1). First, new account 116(2) with entity 102(3) is now reflected in decentralized ledger 140(2). This operation pertains to the transaction request information 192 originally submitted by agent 104(1). Second, entity 102(1) is now associated with a new public key identifier 190(2), which according to one embodiment is effectively address 122(2). This rotation of public key identifier from 190(1) to 190(2) occurred automatically by virtue of client automatically generating new address 122(2) and appending it as a parameter to transaction request information 192 to form transaction 120. That is, decentralized transaction system 106 is adapted to upon receiving transaction 120 with address 122(2) as a parameter to automatically perform not only the requested operation specified in transaction request information 192 but also a public key identifier rotation process to update public key identifier from 190(1) to 190(2) (i.e., address 122(2). Effectively, then, the requested operation encoded in transaction request information 192 and the rotation of public key identifier from 190(1) to 190(2) has been performed as a single atomic transaction.

As previously noted, decentralized ledger 140(1) is only updated or closed to reflect transaction 120 if transaction 120 is authenticated and validated by distributed transaction system 106. Example methods for operation of a consensus process associated with decentralized transaction system 106 are described in detail below. Thus, although FIG. 1a depicts the direct updating of decentralized ledger 140(1) to 140(2), it will be understood that transaction 120 must undergo a consensus process (described in detail below) before decentralized ledger 140(1) is updated to 140(2).

According to an embodiment, an entity 102 may be associated with a master key (comprising corresponding public and private master keys) and a regular key (comprising corresponding public and private regular keys). If the master key is disabled, the regular key may be used to perform authentication with respect to transactions 120 performed for entity 102(1). An API method may be provided for initiating a transaction 120 for rotation of the regular key with respect to entity 102, which may be updated in decentralized ledger 140 if such key rotation transaction is authenticated and validated. The transferring agent 104 of the assets may disable the master key associated with entity 102 and assign a regular key, which allows the agent 104 owning the assets to perform transactions 120 using the regular key. The intended transferee agent 104 of assets may then generate a regular key from a random seed 302 using a key generation process. The intended transferee agent 104 of the assets may then transmit the public key for the new regular key to agent 104 currently owning the assets. The transferring agent 104 may then initiate a key rotation transaction 120 whereby the key associated with entity 102 is now assigned to the key provided by the intended transferee agent 104. Because the intended transferee agent 104(2) owns the secret key/random seed 302 associated with the public key, which has been set in decentralized ledger 140 for the entity 102(1), the intended transferee agent 104(2) now owns the multiple assets 116(1)-116(2) associated with entity 102(1).

Thus, because for each transaction 120 performed with respect to decentralized transaction system 106, an automatic public key identifier rotation process is performed, the public key is never directly exposed in decentralized ledger 140. However, the new public key identifier 190(2) is potentially available to malicious actors due to the fact that during the consensus process it will be broadcast amongst servers 108(1)-108(N) and thus during the period between receipt of transaction 120 and consensus being achieved public key identifier 190(2) is vulnerable to attack via, for example, a quantum algorithm. However, the attack time window has been significantly reduced to the time between ledger updates (140(1)-140(2)), which according to some embodiments may be on the order of seconds. Furthermore, because public key identifier 190(2) is never directly exposed in decentralized ledger 140, the difficulty posed to a potential attacker is significantly increased. In particular, in order to successfully perform a public key attack in the context of the security system shown in FIG. 1a, a malicious actor would have to (a) intercept the submitted transaction 120; (b) break the public key identifier 190(2) (e.g., employ a quantum algorithm to determine the associated private key), (c) create and sign a new transaction; (d) broadcast the new transaction to decentralized transaction system 106.

FIG. 2a is a flowchart of a process for automatically securing transactions in a decentralized transaction process from attacks on a public key exposed in the ledger according to one embodiment of the present disclosure. Public key security process 200 shown in FIG. 2a may be implemented on client 112 or on a network node remote from client 112. The process shown in FIG. 2a may be understood as pertaining to the diagrammatic depiction in FIG. 1a. As will be evident from the discussion with respect to FIG. 1a, public key security process 200 may be implemented with respect to a decentralized ledger 140 in the context of a decentralized transaction system 106. Public security key process 200 is resistant to attacks on a public key and in particular attacks carried out by a quantum algorithm executing on a quantum computer. As previously noted, and as described in more detail below, servers 108(1)-108(N) operate to perform among other things a consensus process over peer-to-peer layer 406 using decentralized consensus layer 408 with respect to transactions 120 initiated by clients 112. Decentralized ledger 140 is updated to reflect transactions 120 that have been authenticated and verified via decentralized consensus layer 408. In particular, the updating of decentralized ledger 140, is performed by decentralized transaction system 106, which further includes decentralized leger 104, decentralized consensus layer 408 and peer-to-peer layer 406 all of which will be described in more detail below.

Thus, for purposes of discussion with respect to FIG. 2a, it is assumed and not explicitly stated that any transactions 120 that are received and then updated in decentralized ledger 140 are transactions 120 for which decentralized consensus layer 408 has reached consensus. Furthermore, according to alternative embodiments, the process shown in FIG. 2a may be understood to occur at a single node or other computational element rather than using decentralized transaction system 106.

Referring now to FIG. 2a, public key security process 200 is initiated in 202. As previously noted, public key security process 200 may be implemented on client 112 and may be automatically performed with respect to each and every transaction request information 192 submitted by agent 104(1) via API 110 to client 112. In 204, transaction request information 192 (described above) is received. In 206, address 122(2) is generated from transaction request information. As previously noted, address 122(2) may be generated by a process, described in detail below, by first processing a random seed or secret to generate a public and associated private key. The public and public key pair is herein referred to as a regular key, as previously described, to distinguish that keypair from a master keypair from address 122(1), which is associated with entity 102(1) in a fixed and persistent manner. It is assumed for purposes of this discussion that the master keypair has been disabled and therefore any number of regular keypairs may be associated with entity 102(1) via a public key identifier rotation process.

Address 122(2) may be then generated from the public regular key by applying a hash function which is a one way function to the public regular key to generate a binary hash and then applying an encoding function, which may be a two-way function, to the binary hash to generate address 122(2). Because address 122(2) is generated via a path that traverses a one-way function, it is resistant to quantum or classical algorithms for calculating the public key from address 122(2). In contrast to the threat quantum computing poses to current public-key algorithms, most current symmetric cryptographic algorithms and hash functions are considered to be relatively secure against attacks by quantum computer

Further, as previously noted, address 122(2) operates as public key identifier 190(2) as it is generated from the public regular key and may be rotated (i.e., changed any number of times). In 208, transaction 120 is generated from transaction request information 192 and address 122(2), for example, by including address 122(2) as a parameter in transaction 120. In 210, transaction 210 is submitted to decentralized transaction system 106, whereupon it may or may not be authenticated and/or validated by decentralized consensus layer 408 operating over peer-to-peer layer 406. The process ends in 212.

As will be described in more detail below, upon submission of transaction 120 to decentralized transaction system 106, by virtue of the fact that transaction 120 includes address 122(2) as a parameter, decentralized transaction system and in particular a consensus process executed by each server 108(1)-108(N) comprising decentralized consensus layer 408 is adapted to automatically perform the operation indicated by transaction request information 192 as well as perform a public key rotation by rotating public key identifier 190(1) to public key identifier 190(2) with respect to entity 102(1). Thus, 140(1) and 140(2) respectively represent the state of decentralized ledger prior to decentralized transaction system 106 having achieved consensus with respect to transaction 120 and just after decentralized transaction system 106 having reached consensus with respect to transaction 120.

FIG. 2a1 is a process that may be performed by a decentralized transaction system to carry out an atomic transaction for an operation to be performed with respect to an entity in a decentralized ledger and a public key rotation according to one embodiment of the present disclosure. Upon submission of a transaction 120 to decentralized transaction system 106, if consensus is reached with respect to the transaction, an atomic operation is performed with respect to the operation specified in transaction request information 192 and a public key rotation with respect to address 112(2) embedded as a parameter in transaction 120. By performing such an atomic transaction, the attack time for hacking a private key associated with the regular public key associated with address 122(2) is significantly reduced.

Referring now to FIG. 2a1, public key security atomic transaction process 248 is initiated in 250. In 252, transaction 120 submitted to decentralized transaction system 106 is received. In particular, each node 108(1)-108(N) may be adapted to receive transactions 120 submitted by clients 112. Further, each node 108(1)-108(N) may operate to perform a consensus process. That is, the collective execution of nodes 108(1)-108(N) in performing respective consensus processes operates to provide a decentralized consensus layer 408. The operation of decentralized transaction layer 408 is described in detail below. In 254, it is determined whether consensus has been achieved with respect to transaction 120. If not (‘No’ branch of 254, the process ends in 260.

If consensus has been reached (‘Yes’ branch of 254) in 256, transaction metadata 172 is updated or generated. In particular, according to one embodiment of the present disclosure, metadata associated with a public key rotation process may be updated to reflect the new public key identifier 190(2). In 258, the updated transaction metadata 172 is updated in ledger 140 to represent the operation identified in transaction 120 as well as the public key identifier rotation process, wherein such transaction metadata may include updated public key identifier 190(2)/address 122(2). Although ledger 140 now may include updated public key identifier 190(2), a malicious actor may not utilize that information determine the private key associated with the public regular key utilized to generate address 122(2) due to the fact that address 122(2) is generated using a one-way function. The process ends in 260.

public key security atomic transaction process 248 may be performed independently by each network node 108(1)-108(N). Alternatively, a specific logical entity or server in the network may perform the process. According to one embodiment of the present disclosure transaction 120 may utilize the following format:

```
{ ″TransactionType″ : ″Pay_and_Rotate″,
  ″Account″ : ″rf1BiGeXwwQoi8Z2ueFYTEXSwuJYfV2Jpn″,
  ″Destination″ : ″ra5nK24KXen9AHvsdFTKHSANinZseWnPcX″,
  ″Amount″ : {
    ″currency″ : ″USD″,
    ″value″ : ″1″,
    ″issuer″ : ″rf1BiGeXwwQoi8Z2ueFYTEXSwuJYfV2Jpn″
  },
  ″Fee″: ″12″,
  ″Flags″: 2147483648,
  ″Sequence″: 2,
  ″RegularKey″: ″rAR8rR8sUkBoCZFawhkWzY4Y5YoyuznwD″
}
```

FIG. 2b is a flowchart depicting a process for the generation of an address from a random seed according to an embodiment of the present disclosure. The process shown in FIG. 2b pertains to 204(a) in FIG. 2a. As previously described, an address 122 may be associated with an entity 102 in order to allow a particular agent 104 to perform authenticate transactions 120 with respect to that entity 102. The process is initiated in 220. In 222, private key 306 is generated from random seed 302. In 224, public key 308 is generated from random seed 302. According to an embodiment of the present disclosure, generation of private key 306 and public key 308 are performed using a one-way function using random seed 302. In 226, binary hash 312 is generated from public key 308. According to an embodiment of the present disclosure, binary hash 312 is generated using a one-way function. In 228, an encoding process is performed to generate address 122 from binary hash 312. According to an embodiment of the present disclosure, generation of address 122 from binary hash 312 is performed using a two-way function. The process ends in 229.

FIG. 2c is a flowchart for performing an authentication of a transaction according to an embodiment of the present disclosure. Transaction authentication process 230 may be performed with respect to any transactions 120 received in decentralized transaction system 106. For a proposed transaction to be included in decentralized ledger 140, both authentication and verification may be required. FIG. 2c specifically shows an authentication process that may be performed by a single server 108. Upon authentication, in order for a proposed transaction 120 to be verified and thereby reflected in decentralized ledger 140, it may be expected or required for decentralized consensus layer 408 (described below) to reach consensus with respect to that transaction 120. The operation of decentralized consensus layer 408 is described in detail below.

According to an embodiment of the present disclosure, each transaction 120 may be a triple comprising public key 308, transaction ID 316 and transaction signature 318. The structure and a process for generation of a transaction 120 will be described in detail below with respect to FIG. 3b. According to an embodiment of the present disclosure, agent 104 utilizes computing device 114 to generate a transaction 120. In 242, transaction 120 is received and the various components of the triple (public key 308, transaction ID 316 and signature 318) are extracted. In 244, it is determined whether transaction signature 318 is valid. If not (‘No’ branch of 244), authentication fails in 246. If so (‘Yes’ branch of 244), flow continues with 245 where the source address 122(1) is extracted from transaction ID 316. In particular, according to an embodiment of the present disclosure, the address 122 associated with the entity 102 for which a transaction 120 is to be performed is embedded in transaction ID 316.

In 246, a hash function is applied to public key 308 to generate binary hash 312. In 248 binary hash is encoded to generate address 122(2). In 250, it is determined whether address 122(1) matches address 122(2). If not (‘No’ branch of 250), authentication fails in 246. Otherwise (‘Yes’ branch of 250), authentication succeeds in 252 and the transaction 120 may be performed.

FIG. 3a depicts a process for the generation of an address from a random seed according to an embodiment of the present disclosure. The process flow in 3a mirrors the flowchart shown in FIG. 2b. Random seed 302 is processed by key generation process 304, which generates private key 306 and public key 308. Public key 308 is processed by hash function 310, which generates binary hash 312. Binary hash 312 is processed by encoding function 314, which generates address 122.

FIG. 3b depicts a process for the generation of a transaction according to an embodiment of the present disclosure. As previously discussed, transaction 120, which may include a triple of a transaction ID 316, transaction signature 318 and public key 308 is transmitted by client 112 in order to initiate an attempted update to decentralized ledger 140 in decentralized transaction system 106. As shown in FIG. 3b, transaction ID 316 and private key 306 are provided to signing algorithm 318, which generates transaction signature 318. Transaction signature 120 is then assembled as a triple comprising transaction ID 316, transaction signature 318 and public key 308.

FIGS. 3c-3d depicts a process for performing an authentication of a transaction according to an embodiment of the present disclosure. The process shown in FIGS. 3c-3d mirrors the flowchart shown in FIG. 2c. In particular, transaction authentication process shown in FIGS. 3c-3d determines both whether an address, which may be regenerated from transaction 120 matches address 122(2) received from public key 122(2) and whether transaction signature 318 is valid.

Referring to FIG. 3c, which shows a first phase of a transaction authentication process, address 122(1) is extracted from transaction 120 using address extract process 322. Meanwhile, transaction signature 318 is processed by signature validation process 324 using public key 308 to generate validation result 326 indicating whether transaction signature 318 is valid or not. In addition, public key 308 is processed by hash function process to generate binary hash 312. Binary hash 312, in turn, is processed by encoding function 332 to generate address 122(2).

Referring now to FIG. 3d, which shows a second phase of a transaction authentication process, source addresses 122(1) and 122(2) are compared by source address comparison process 330 to generate address comparison result 328. Then, validation result 326 and address comparison result 328 are processed by authentication logic process 334 to generate authentication result 336. In particular, if both transaction signature 318 is valid and source addresses 122(1) and 122(2) match, authentication result indicates authentication should be performed. Otherwise, authentication result 336 indicates authentication should not be performed.

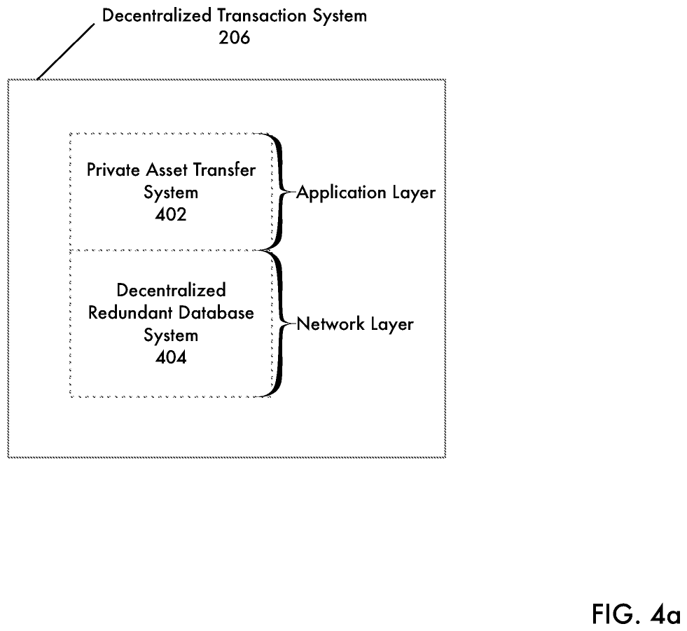

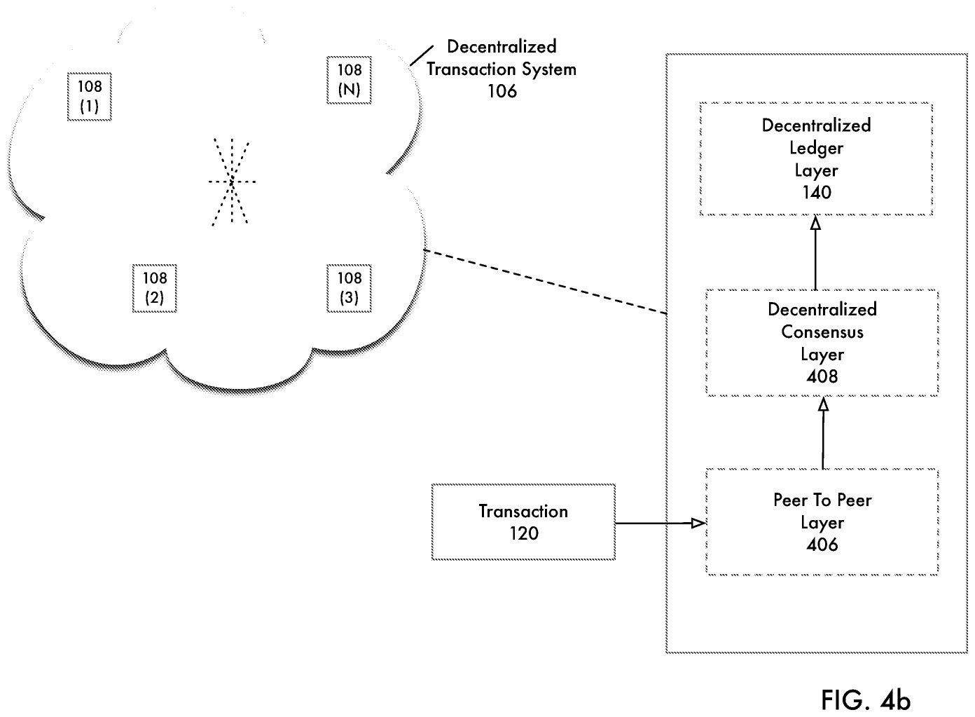

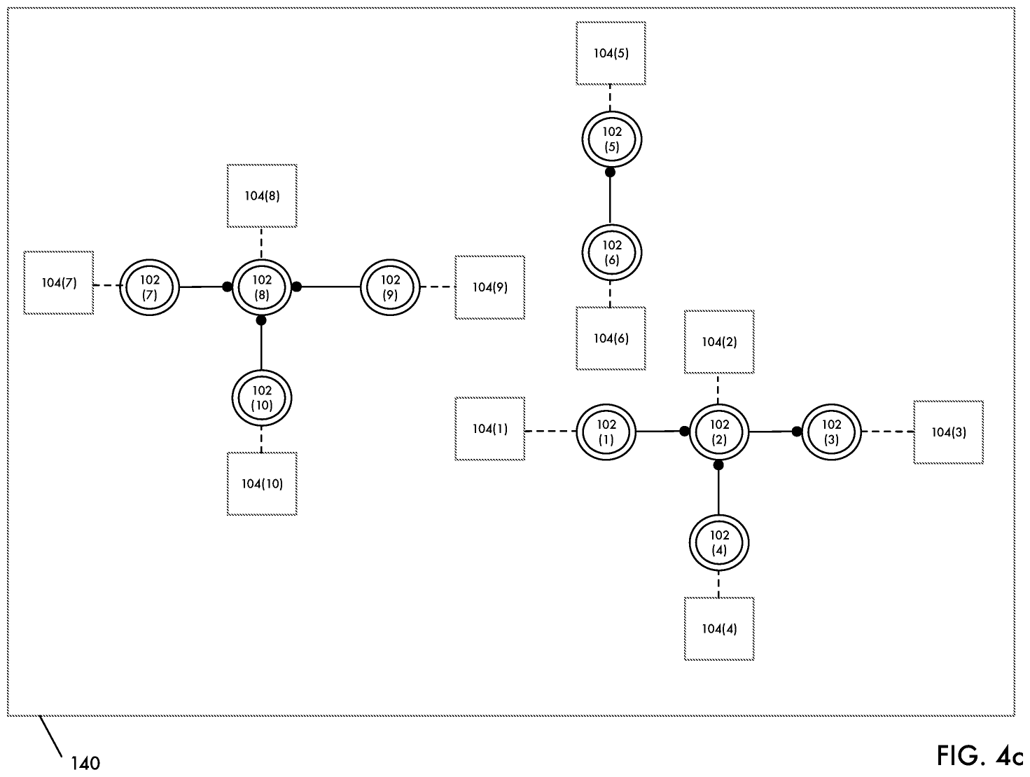

FIG. 4a is a high level block diagram of a decentralized transaction system according to an embodiment of the present disclosure. As shown in FIG. 4a, decentralized transaction system 106 further includes decentralized redundant database system 404 that operates at the network layer and multiple asset transfer system 402 that operates at the application layer. Thus, decentralized redundant database system 404 may power any type of transactions 120, not only the transfer of monetary assets. In this way, according to alternative embodiments of the present disclosure, the transfer of any type of multiple asset or right may be achieved using techniques disclosed herein.

FIG. 4b is a block diagram of a decentralized transaction system according to an embodiment of the present disclosure. The block diagram in FIG. 4b shows more detail than the high-level block diagram of FIG. 4a. Referring to FIG. 4a, decentralized transaction system 106 further includes peer-to-peer layer 406, decentralized consensus layer 408 and decentralized ledger layer 140. Decentralized ledger layer 140 pertains to the element previously referred to as decentralized ledger 140 and will be used interchangeably herein. As previously discussed, decentralized transaction system 106 may further include a number of servers 108(1) that communicate over peer-to-peer layer 406. As will be appreciated, peer-to-peer layer 406 allows for the exchange of information between any number of servers 108(1)-108(N) without the need for a centralized server. Thus, each server 108(1)-108(N) operating over peer-to-peer layer 406 operates as a file server as well as a client. Each server 108(1)-108(N) runs a server process, which facilitates any client communicating with that respective server to initiate transactions 120 (such as the sending and receiving of assets) with respect to decentralized transaction system 106.

In addition, such server process executed on each respective server 108(1)-108(N) participates in a consensus process as described in more detail below.

FIG. 4c depicts an example of a ledger in graphical form according to an embodiment of the present disclosure. FIG. 4c depicts an example state of decentralized ledger 140. It will be understood the format for representing transactions 120 in decentralized ledger 140 may assume a multitude of representations. Thus, FIG. 4c simply shows one example state of a decentralized ledger 140. Referring now to FIG. 4c, entities 102(1)-102(10) are respectively owned by agents 104(1)-104(10). This ownership is established by virtue of each respective agent 104 possessing a secret key/random seed 302 from which a respective address 122 and private/public keys 306/308 have been associated with the corresponding entity 102. Thus, for example, agent 104(1) utilized a secret key to generate an address that has been associated with entity 102(1), for example, by performing an address setting transaction 120.

FIG. 4c also shows that entities 102(1), 102(3) and 102(4) have established an account 116 with entity 102(2). In particular, this means that an indebtedness exists between entity 102(2) and entities 102(1), 102(3) and 102(4). Similarly, entity 102(6) holds an account 116 with entity 102(5) as do entities 102(7), 102(9) and 102(10) with respect to entity 102(8).

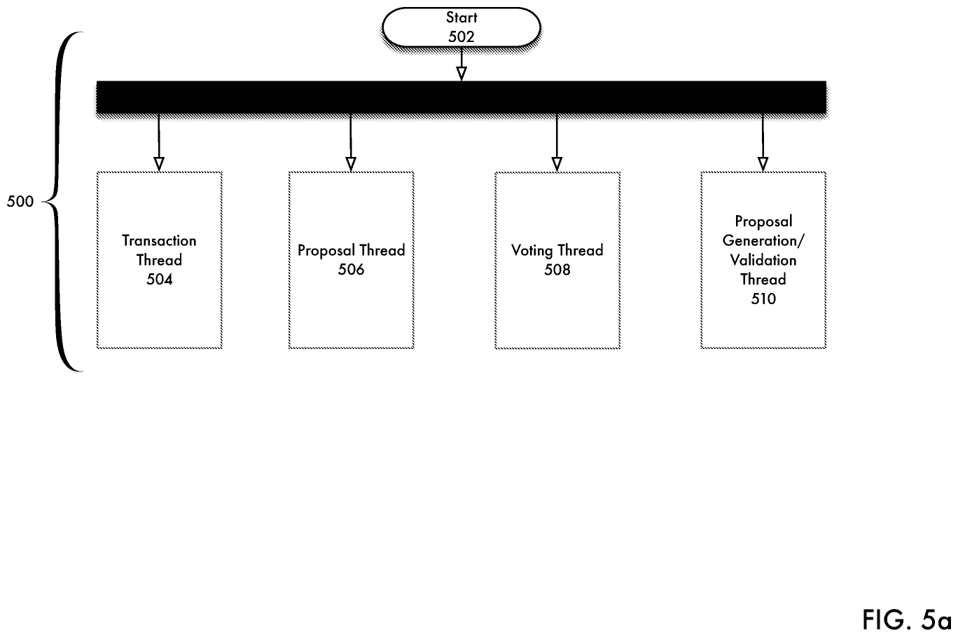

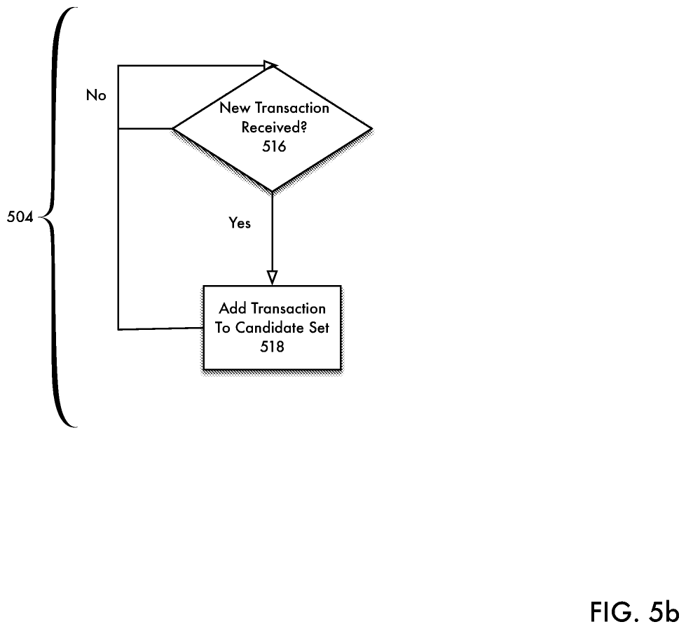

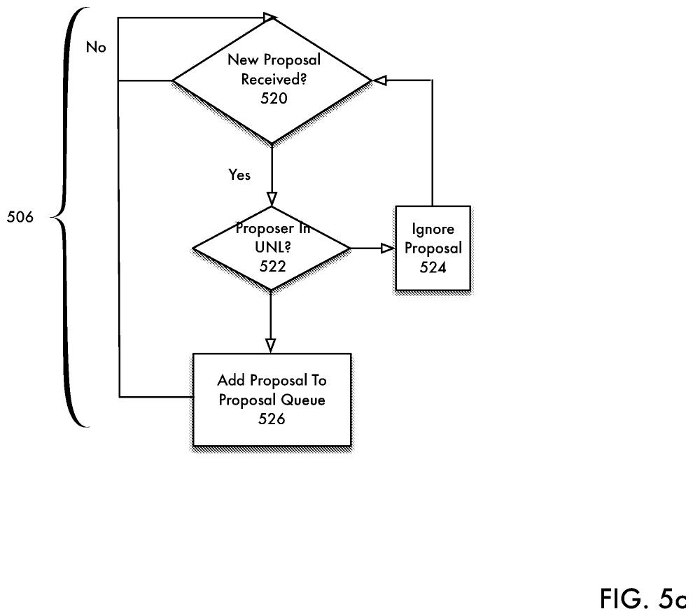

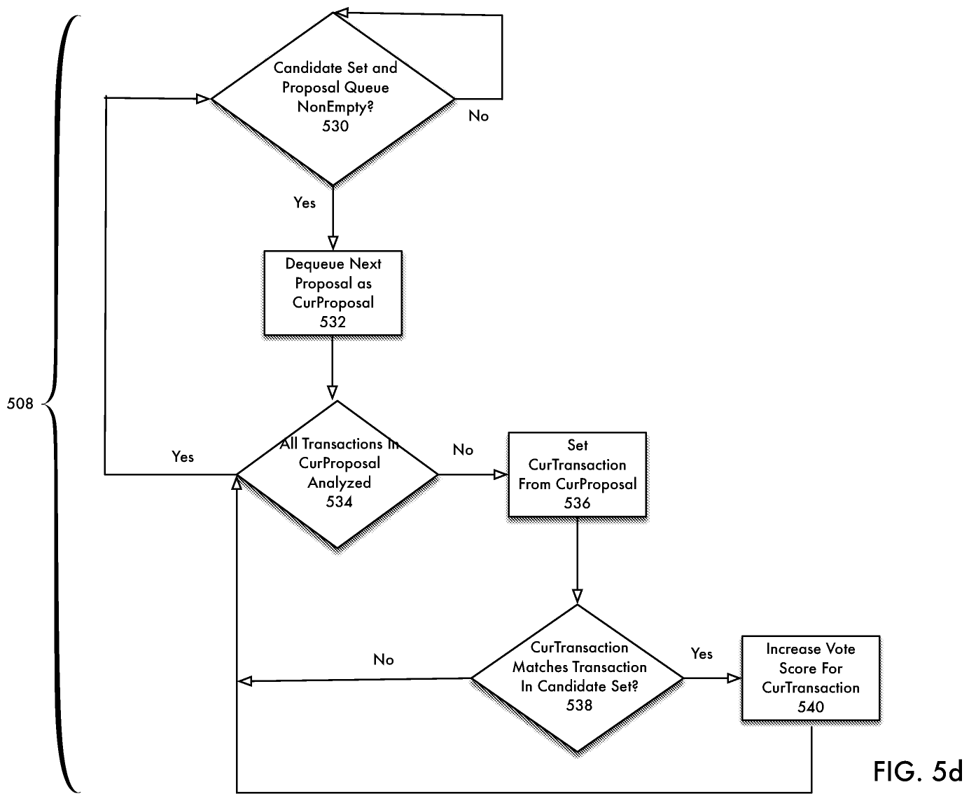

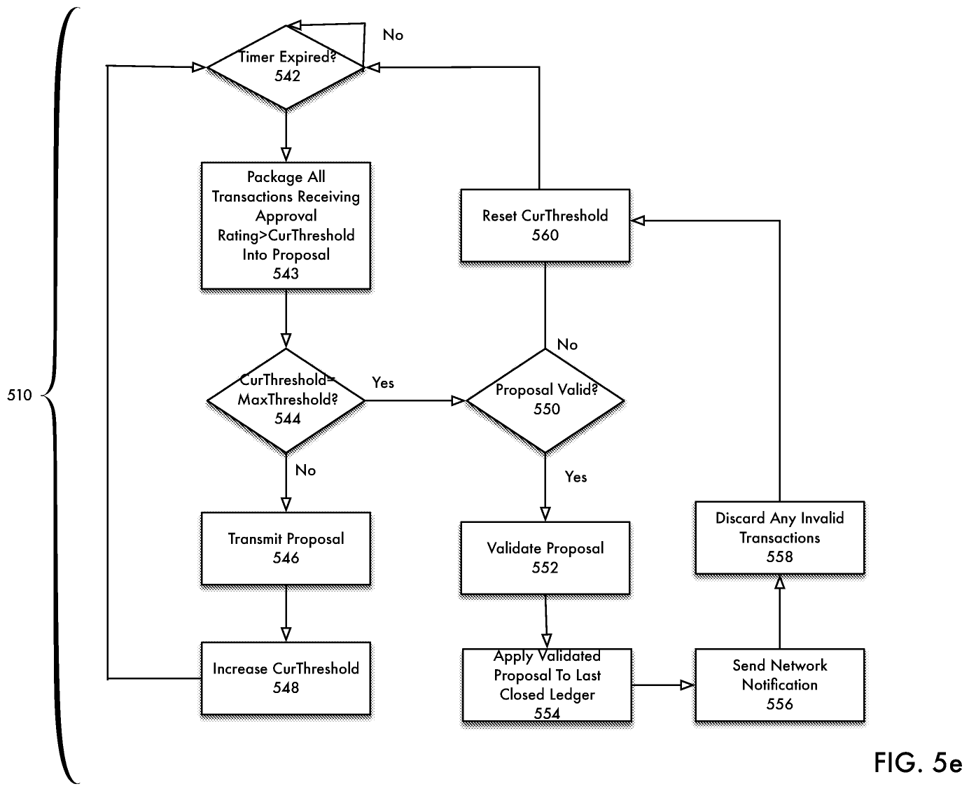

FIG. 5a is a high level flowchart of a consensus process according to an embodiment of the present disclosure. The consensus process 500 shown in FIG. 5a may be performed identically on each of a plurality of servers 108(1)-108(N) communicating over a peer-to-peer network. The collective behavior of all servers 108(1)-108(N) in carrying out the consensus process 500 is referred to herein as a consensus protocol. The goal of consensus for each server 108(1)-108(N) to apply the same set of transactions 120 to the ledger. Referring to FIG. 5a, consensus process 500 may further include transaction thread 504, proposal thread 506, voting thread 508 and proposal generation/validation thread 510. Transaction thread 504 receives transactions 120 from other servers 108(1)-108(N) communicating over peer-to-peer layer 406 and places those transactions 120 in a candidate set. A candidate set is a pool of transactions 120 waiting to be added to the ledger and may be stored in a queue or other suitable data structure. Simultaneously, proposal thread 506 receives proposals from other servers 108(1)-108(N) communicating over peer-to-peer layer and places those proposals in a queue. A proposal includes a proposed set of transactions 120 to be included in the current ledger such that each transaction 120 in a proposal has received a number of votes for inclusion in the ledger that exceeds a pre-determined threshold. Voting thread 508 performs voting by comparing transactions 120 stored in the candidate set with transactions 120 retrieved from stored proposals.

FIG. 5b is a flowchart depicting an operation of a transaction thread according to an embodiment of the present disclosure. As shown in FIG. 5b, transaction thread 504 may operate by determining whether a new transaction 120 has been received in 516. If no new transaction 120 has been received (‘No’ branch of 516), flow continues with 516 and the thread continues to wait for new transactions 120. Otherwise (‘Yes’ branch of 516) flow continues with 518 and the transaction 120 is placed in a candidate set, which may include a queue or other suitable data structure.

FIG. 5c is a flowchart depicting an operation of a proposal thread according to an embodiment of the present disclosure. Proposal thread 506 receives proposals from other servers (e.g., 108(1)-108(N)). According to an embodiment of the present disclosure, each server performing a consensus process 500 may store a unique node list (“UNL”). The UNL is a list of trusted external servers 108. Each server 108 has its own respective UNL. Referring now to FIG. 5c, in 520, it is determined whether a new proposal has been received. If not (‘No’ branch of 520), flow continues with 520 and the server 108 continues to wait for new proposals. If so (‘Yes’ branch of 520), flow continues with 522 where it is determined whether the proposal (the server 108 generating the proposal) is included in the UNL. If not (‘No’ Branch of 522), flow continues with 524 and the proposal is ignored. Flow then continues with 520 whereby the server 108 waits for new proposals. If the proposer is in the UNL (‘Yes’ branch of 522), flow continues with 526 whereby the received proposal is added to a queue of proposals for consideration by voting thread.

FIG. 5d is a flowchart depicting an operation of a voting thread according to an embodiment of the present disclosure. Transactions 120 in received proposals are compared with transactions 120 in the candidate set. When a transaction 120 in a proposal matches a transaction 120 in the candidate set, that transaction 120 receives one vote. Referring now to FIG. 5d, in 530 it is determined whether both the candidate set and the proposal queue are non-empty. If not (‘No’ branch of 530), flow continues with 530 and the test is performed again. If so (‘Yes’ branch of 530), flow continues with 532 and the next proposal is dequeued from the proposal queue and set to a variable CurProposal. In 534, it is determined whether all transactions 120 in the proposal identified by CurProposal have been analyzed. If so (‘Yes’ branch of 534), flow continues with 530. If not (‘No’ branch of 534), flow continues with 536 and the next transaction 120 in CurProposal is set to a variable called CurTransaction. In 538, it is determined whether the transaction 120 identified by CurTransaction matches a transaction 120 in the candidate set. If not (‘No’ branch of 538), flow continues with 534 and the next transaction 120 is analyzed. If so (‘Yes’ branch of 538), flow continues with 540 and the vote for the transaction 120 identified by CurTransaction is incremented. According to an embodiment of the present disclosure, each transaction 120 may include a data field for tracking votes. According to alternative embodiments, votes for transactions 120 may be stored in a separate data structure.

FIG. 5e is a flowchart depicting an operation of a proposal generation/validation thread according to an embodiment of the present disclosure. The process shown in FIG. 5e may be performed by proposal generation/validation thread 510. As previously described, transactions 120 and transmitted between servers 108(1)-108(N) and are packaged intro proposals, which are also transmitted between servers 108(1)-108(N). Each time a proposal in the candidate set of a particular server 108 is considered for inclusion into the next ledger, it may undergo a voting round in which it is compared with transactions 120 in received proposals. According to an embodiment of the present disclosure, each transaction 120 may be associated with an approval rating, which indicates a percentage of votes for that transaction's 120 inclusion in the next ledger out of the total number of voting entities that cast a vote with respect to that transaction 120. For example, if a transaction 120 was considered for inclusion in a proposal 10 times and received 4 votes, the approval rating for the proposal would be 40%.

According to an embodiment of the present disclosure, the determination of whether a transaction 120 should be included in a proposal is based upon whether that transaction 120 has an approval rating exceeding a predetermined threshold. According to an embodiment of the present disclosure, the threshold may be a dynamic variable that changes over time and is referred to herein as CurThreshold. In particular, according to an embodiment of the present disclosure, a parameter referred to herein as MaxThreshold may be defined. MaxThreshold indicates a required approval rating that must be established for all transactions 120 in a proposal for that proposal to be used to update the current ledger in order to generate a new last closed ledger.

Referring now to FIG. 5e, in 542 it is determined whether a timer has expired. If not (‘No’ branch of 542), flow continues with 542 and the timer is checked again. If so (‘Yes’ branch of 542), flow continues with 543 whereby all transactions 120 receiving an approval rating exceeding CurThreshold are packaged into a new proposal. It is assumed for purposes of this example that CurThreshold was initialized at startup of proposal generation/validation thread 510. In 544, it is determined whether CurThreshold-MaxThreshold. If not (‘No’ branch of 546), flow continues with 546 and the generated proposal is transmitted to the network (peer-to-peer layer 406). In 548, CurThreshold is increased by some predetermined increment. Flow then continues with 542 and the process is repeated again.

If CurThreshold=MaxThreshold as determined in 544 (‘Yes’ branch of 544), flow continues with 550 where it is determined whether the current proposal is valid. According to an embodiment of the present disclosure, the validity of a proposal is determined based upon whether all transactions 120 in the proposal have an approval rating exceeding MaxThreshold. If all transactions 120 in the proposal do not exceed MaxThreshold (‘No’ branch of 550), flow continues with 560 and the CurThreshold parameter is reset to its lowest value. Flow then continues with 542.

If all transactions 120 have an approval rating equal to or exceeding MaxThreshold, in 552, the proposal is validated, meaning that all transactions 120 in the proposal will be utilized to update the current ledger to generate a last closed ledger. Flow then continues with 554 wherein the validated proposal is applied to the last closed ledger. In 556, a network notification is generated and transmitted indicating a new last closed ledger has been generated. In 558, any invalid transactions 120 in the candidate set are discarded. Flow then continues with 560 whereby the CurThreshold parameter is reset.

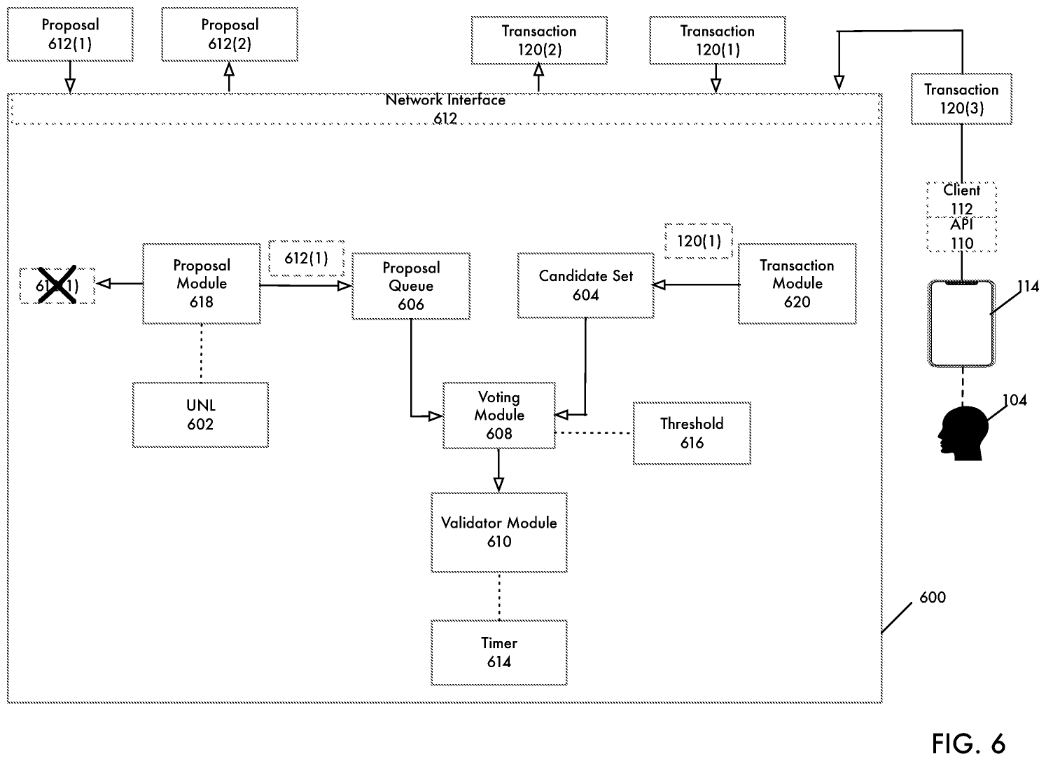

FIG. 6 is a block diagram of a consensus system according to an embodiment of the present disclosure. Consensus system 600 may run on each of a plurality of servers (e.g., 108(1)-108(N)), which may interoperate via peer-to-peer layer 406. Servers 108(1)-108(N) may each run consensus process 500 as described above respect to FIGS. 5a-5e. Consensus system may include transaction module 620 for handling incoming transactions 120, proposal module 618 for handling incoming proposals 612, voting module 608 for performing voting on transactions 120, validator module 610 for performing validation of proposals 612 for updating the current decentralized ledger 140. Consensus system 600 may further include candidate set 604 for storing incoming transactions 120 and proposal queue 606 for storing incoming proposals. Consensus system 600 may further include UNL 602 for storing a list of trusted servers 108, threshold module for storing a current approval threshold value and timer 614.

The operation of consensus system 600 will now be described. As previously noted, the collective operation of a distributed transaction system 106 allows for the initiation and consummation of transactions 120 in a decentralized manner. In order to facilitate trust in the validity and authenticity of transactions 120 initiated by agents (e.g., 104) according to an embodiment of the present disclosure, a decentralized consensus process may be utilized to validate and authenticate transactions 120, which may then be reflected in decentralized ledger 140. Thus, as shown in FIG. 6, agent 104 may utilize computing device 114 to generate a candidate transaction 120(3) utilizing API 110 and client 112 running on computing device 114. For example, transaction 120(3) may relate to the rotation of an address 122 with respect to an entity 102 in order to transfer multiple assets associated with entity 102 to an agent 104 providing a new address 122.

In this instance, for example, it is essential to insure that the transaction 120 is valid, i.e., there is no reason that the agent 104 may be attempting to perform a malicious or fraudulent transaction 120. For example, agent 104 may attempt to rotate a key twice with respect to the same entity 102, which is invalid. This type of malicious behavior should be prevented by the collective operation of the consensus process 600 carried out in a distributed manner via servers 108(1)-108(N). Further, the consensus process 600 as carried out in a decentralized environment should also detect unauthenticated transactions 120 (e.g., attempts by an agent 104 to perform transactions 120 with respect to entities 102 that they are not associated with (do not own)).

Although FIG. 6 shows a single consensus system 600, it will be understood that each server 108(1)-108(N) may run an identical consensus system 600. Each of a plurality of agents 104 attempting to initiate respective transactions 120 may use respective computing devices 114 running client 112 and API 110 in order to generate transactions 120, which are transmitted to one of the servers 108(1)-108(N). Transaction module 620 operates to received transactions 120 (e.g., 120(1)) either directly from a client 112 or from other servers 108(1)-108(N) and store them in candidate set 604, which may include a queue or other suitable data structure. In particular, according to an embodiment of the present disclosure, all servers (e.g., 108(1)-108(N)) running a respective consensus process 600 transmit received transactions 120 provided by clients to all other servers 108(1)-108(N), which are received as incoming transactions 120(1) and are also stored in candidate set 604. In effect, candidate set 604 stores transactions 120 generated by clients 112 or transmitted from other servers 108(1)-108(N) that are candidates for inclusion in an updated ledger.

According to an embodiment of the present disclosure, consensus system 600 operates to package transactions 120 meeting a threshold level of approval into a group referred to as a proposal 612 that includes a potential set of transactions 120 to be applied to the current ledger. These proposals are also transmitted amongst servers 108(1)-108(N) running consensus system 600 where they are received (612(1)) by proposal module 618, which executes proposal thread 506. Proposal module 618 then compares the server identity of the transmitting proposal 612 against UNL 602. If the transmitting server 108 is not in UNL 602, the proposal 612 is discarded. If, on the other hand, the received proposal is stored in proposal queue 606.

Voting module 608 operates simultaneously to execute voting thread 508, which performs voting with respect to transactions 120 in candidate set 604 by comparing the identity of those transactions 120 in proposals 612 in proposal queue 606.

Validator module 610 executes proposal generation/validation thread 510, which upon expiration of a timer attempts to generate a new proposal based upon threshold 610 for transmission to other servers 108(1)-108(N) or if threshold 610 is at its maximum value, attempts to generate a valid proposal for updating the current decentralized ledger 140.

It will be understood that peer-to-peer layer 406 may operate over any network any type of public or private network including the Internet or LAN.

As will be further appreciated, computing device 114, includes and/or otherwise has access to one or more non-transitory computer-readable media or storage devices having encoded thereon one or more computer-executable instructions or software for implementing techniques as variously described in this disclosure. The storage devices may include any number of durable storage devices (e.g., any electronic, optical, and/or magnetic storage device, including RAM, ROM, Flash, USB drive, on-board CPU cache, hard-drive, server storage, magnetic tape, CD-ROM, or other physical computer readable storage media, for storing data and computer-readable instructions and/or software that implement various embodiments provided herein. Any combination of memories can be used, and the various storage components may be located in a single computing device 114 or distributed across multiple computing devices 114. In addition, and as previously explained, the one or more storage devices may be provided separately or remotely from the one or more computing devices 114. Numerous configurations are possible.

In some example embodiments of the present disclosure, the various functional modules described herein and specifically training and/or testing of network 340, may be implemented in software, such as a set of instructions (e.g., HTML, XML, C, C++, object-oriented C, JavaScript, Java, BASIC, etc.) encoded on any non-transitory computer readable medium or computer program product (e.g., hard drive, server 108, disc, or other suitable non-transitory memory or set of memories), that when executed by one or more processors, cause the various creator recommendation methodologies provided herein to be carried out.

In still other embodiments, the techniques provided herein are implemented using software-based engines. In such embodiments, an engine is a functional unit including one or more processors programmed or otherwise configured with instructions encoding a creator recommendation process as variously provided herein. In this way, a software-based engine is a functional circuit.

In still other embodiments, the techniques provided herein are implemented with hardware circuits, such as gate level logic (FPGA) or a purpose-built semiconductor (e.g., application specific integrated circuit, or ASIC). Still other embodiments are implemented with a microcontroller having a processor, a number of input/output ports for receiving and outputting data, and a number of embedded routines by the processor for carrying out the functionality provided herein. In a more general sense, any suitable combination of hardware, software, and firmware can be used, as will be apparent. As used herein, a circuit is one or more physical components and is functional to carry out a task. For instance, a circuit may be one or more processors programmed or otherwise configured with a software module, or a logic-based hardware circuit that provides a set of outputs in response to a certain set of input stimuli. Numerous configurations will be apparent.

The foregoing description of example embodiments of the disclosure has been presented for the purposes of illustration and description. It is not intended to be exhaustive or to limit the disclosure to the precise forms disclosed. Many modifications and variations are possible in light of this disclosure. It is intended that the scope of the disclosure be limited not by this detailed description, but rather by the claims appended hereto.

What is claimed is:

1. A method for securing transactions performed in a decentralized transaction system from public key attacks comprising:
receiving transaction request information specifying an operation with respect to an entity in a decentralized ledger;
generating a public key identifier for said entity;
generating a transaction based upon said transaction request information and said public key identifier; and,
submitting said transaction to said decentralized transaction system, wherein said transaction causes said decentralized transaction system to perform a public key identifier rotation process and said operation as an atomic operation.

2. The method according to claim 1, wherein said public key identifier is generated from a secret key by:
generating a public key;
hashing said public key to generate a binary hash; and,
encoding said binary hash to generate said public key identifier.

3. The method according to claim 2, wherein said public key identifier is incorporated as a parameter in said transaction.

4. The method according to claim 1, wherein each transaction further comprises a transaction identifier, a transaction signature and a public key associated with an agent generating said transaction.

5. The method according to claim 1, wherein said decentralized transaction system further comprises a peer-to-peer layer, a decentralized ledger layer and a decentralized consensus layer.

6. The method according to claim 5, wherein said decentralized consensus system, upon authenticating and verifying said transaction via said consensus layer, replaces a previous public key identifier with said public key identifier.

7. The method according to claim 6, wherein said decentralized consensus system includes a transaction in a decentralized ledger if said transaction achieves an approval rating greater than a predetermined threshold.

8. A decentralized system for securely performing transactions comprising:
a peer-to-peer layer;
a decentralized ledger layer; and,
a decentralized consensus layer, wherein said decentralized consensus layer operates to:
receive a transaction, wherein said transaction indicates an operation to be performed with respect to an entity in said decentralized ledger layer and a public key identifier; and
perform an atomic transaction comprising performing said operation and a public key rotation process utilizing said public key identifier.

9. The system according to claim 8, wherein said public key identifier is generated from a secret key.

10. The system according to claim 9, wherein said decentralized consensus layer performs said atomic transaction by:
generating transaction metadata; and
updating a decentralized ledger utilizing said transaction metadata.

11. The system according to claim 10, wherein said transaction metadata indicates an operation performed with respect to said entity and an updating of said public key identifier with respect to said entity.

12. The system according to claim 8, wherein each transaction further comprises a transaction identifier, a transaction signature and a public key associated with an agent generating said transaction.

13. The system according to claim 8, wherein said public key identifier is generated using a one-way function from a public key.

14. The method according to claim 8, wherein said decentralized consensus layer includes a transaction in a decentralized ledger if said transaction achieves an approval rating greater than a predetermined threshold.

15. A computer program product including one or more non-transitory machine-readable media encoded with instructions that when executed by one or more processors cause a process to be carried out for securing transactions performed in a decentralized transaction system from public key attacks comprising:
receiving transaction request information specifying an operation with respect to an entity in a decentralized ledger;
generating a public key identifier for said entity;
generating a transaction based upon said transaction request information and said public key identifier; and,
submitting said transaction to said decentralized transaction system, wherein said transaction causes said decentralized transaction system to perform a public key identifier rotation process and said operation as an atomic operation.

16. The computer program product according to claim 15, wherein said public key identifier is generated from a secret key by:
generating a public key;
hashing said public key to generate a binary hash; and,
encoding said binary hash to generate said public key identifier.

17. The computer program product according to claim 15, wherein said public key identifier is incorporated as a parameter in said transaction.

18. The computer program product according to claim 15, wherein each transaction further comprises a transaction identifier, a transaction signature and a public key associated with an agent generating said transaction.

19. The computer program product according to claim 15, wherein said decentralized transaction system further comprises a peer-to-peer layer, a decentralized ledger layer and a decentralized consensus layer.

20. The computer program product according to claim 18, wherein said decentralized consensus system, upon authenticating and verifying said transaction via said consensus layer, replaces a previous public key identifier with said public key identifier.

21. The computer program product according to claim 19, wherein said decentralized consensus system includes a transaction in a decentralized ledger if said transaction achieves an approval rating greater than a predetermined threshold.
